(19) United States
(12) Patent Application Publication
(10) Pub. No.: US 2021/0161173 A1
(43) Pub. Date: Jun. 3, 2021

(54) SUPER-VOLUMETRIC HIGHLY REFINED CELLULOSE IN VEGAN MEAT-ALTERNATIVE COMPOSITIONS

(71) Applicants: Brock M. Lundberg, Hudson, WI (US); Shuai Li, Lake Elmo, MN (US)

(72) Inventors: Brock M. Lundberg, Hudson, WI (US); Shuai Li, Lake Elmo, MN (US)

(73) Assignee: Fiberstar, Inc., River Falls, WI (US)

(21) Appl. No.: 17/093,694

(22) Filed: Nov. 10, 2020

Related U.S. Application Data
(60) Provisional application No. 62/942,260, filed on Dec. 2, 2019.

(51) Int. Cl. A23J 3/22; A23J 3/26; A23J 3/14; A23J 3/24

(52) U.S. Cl. CPC A23J 3/227; A23J 3/24; A23J 3/14; A23J 3/26

(57) ABSTRACT

Methods enable formation of coarse refined cellulose fibers that improve the texture and coarseness of meat analogs to more closely represent ground beef. The refined cellulose fibers can also be efficiently converted into gels and vegan protein mass. The coarse fibers have average lengths of diameters of over 1000 microns as compared to typical high quality, highly refined, fine cellulose fibers of <700 microns or less than 600 microns. The refined cellulose fibers (coarse or fine) may be blended with alginate and edible vegan oil to form gels when triggered with acid conditions that crosslink the alginate into a stable vegan gel.

### BACKGROUND OF THE INVENTION

### 1. Field of the Invention

The present invention relates to the field of food compositions, materials used in preparing food compositions and alternative foodstuffs (including vegan “meats”) useful for human consumption.

### 2. Background of the Art

A meat analogue, also called a meat alternative, meat substitute, mock meat, faux meat, imitation meat, vegetarian meat, or vegan meat, approximates certain aesthetic qualities (such as texture, flavor, appearance) or chemical characteristics of specific types of meat. Generally, meat analogue means a food made from vegetarian ingredients, and sometimes without animal products such as dairy. Many analogues are soy-based (e.g. tofu, tempeh) or gluten-based, but now may also be made from pea protein.

The target market for meat analogues includes vegetarians, vegans, non-vegetarians seeking to reduce their meat consumption, and people following religious dietary laws in Hinduism, Judaism, Islam, and Buddhism. Increasingly the global demand for sustainable diets in response to the outsized role animal products play in global warming and other environmental impacts has seen an increase in industries focused on finding substitutes similar to meat.

Meat substitution has a long history. Tofu, a popular meat analogue made from soybeans, was known in China during the period of the Western Han dynasty (206 BCE-9 CE). A document written by Tao Gu (903-970) describes how tofu was called “small mutton” and valued as an imitation meat. Meat analogues such as tofu and wheat gluten are associated with Buddhist cuisine in China and other parts of East Asia. In Medieval Europe, meat analogues were popular during the Christian observance of Lent, when the consumption of meat from warm-blooded animals is forbidden.

Soy protein isolates or soybean flour and gluten are usually used as foundation for most meat analogs that are available on the market. Soy protein isolate is a highly pure form of soy protein with a minimum protein content of 90%. The process of extracting the protein from the soybeans starts with the dehulling, or decortication, of the seeds. The seeds are then treated with solvents such as hexane in order extract the oil from them. The oil-free soybean meal is then suspended in water and treated with alkali to dissolve the protein while leaving behind the carbohydrates. The alkaline solution is then treated with acidic substances in order to precipitate the protein, before being washed and dried. The removal of fats and carbohydrates, results in a product that has a relatively neutral flavor. Soy protein is also considered a “complete protein” as it contains all of the essential amino acids that are crucial for proper human growth and development.

Lipids are added to the meat analog in the form of liquid or semi-liquid glyceride shortening from synthesis, or other sources such as plants or animals. The glycerides could potentially contain unsaturated or saturated long chain acyl radicals ranging from 12 to around 22 carbon atoms. Due to the target audience of meat analogs, plant-based lipid sources such as soybean oil, olive oil, canola oil, and others alike are usually used. While lipids do not contribute to the structure of the meat analog, it is crucial in increasing the palatability and broadening the appeal of the product across the consumer base.

Food additives include flavor compounds, coloring agents, leavening agents, and emulsifiers. Sodium bicarbonate is a commonly used leavening agent in a variety of baked products such as bread and pancakes. The carbon dioxide released by sodium bicarbonate aids in the expansion and the unilateral stretching of the protein network during production. A variety of emulsifiers can be used to stabilize the meat analog system. These could include, but are not limited to polyglycerol monoesters of fatty acids, monoacylglycerol esters of dicarboxylic acids, sucrose monoesters of fatty acids, and phospholipids. Polyglycerol monoesters consist on average of 2 to 10 glycerol units and an average of one acyl fatty acid group per glycerol component. The polymer is created from esterification reactions with fatty acids and contains 14 to 16 carbons per polyglycerol moiety. Sucrose monoesters are derived from the esterification of sucrose with a fatty acid ester or a fatty acid and it ideally should have a fatty acyl group ranging from 14 to 18 carbon atoms. Lastly, phospholipid such as lecithin, cephalin, and sphingomyelin can also be used as effective emulsifiers. In addition, some of the emulsifier act as a lubricant during the extrusion process.

Overall, the composition of dry protein mix can contain between 30% to 100% water-hydratable, heat-coagulable protein by weight. A dry mix that contains 100% protein content yields the most desirable fibrous texture, but from the palatability standpoint between 50% to 70% was determined to generate the most positive feedback. Protein content of lower than 30% would inhibit the formation of meat-like fibers during processing. The optimal fat content for the desirable mouth feel was determined to be around 30% to 40% by weight.

Meat analog products are currently made by two basic processes, through either thermoplastic extrusion or fiber spinning. Thermoplastic extrusion involves the adaptation of production processes that are more commonly associated with the making of ready-to-eat cereal products. Extruders are simple in nature and are considered to be a cost-effective method of accommodating large-scale productions. It also provides the conditions that are crucial to the formation of the desirable fibers. The wet mix is mixed in a heated vessel at a temperature lower than the coagulation temperature of the proteins. The elevated temperature assists in lowering the viscosity of the dough and allows for a more homogenized mixing process. Special caution must be taken as to not overmix the dough as it has been known to substantially decrease the amount of fibers formed.

Extruders should be set to the temperature in which the protein used will start to coagulate for max efficiency. Gluten and soy proteins coagulate at 75° C. and 68° C. respectively. Due to the fact that the extruder also cooks the product, the temperature of the inner walls of extruder should be within the range of 77° C. to 149° C. Turbulent conditions caused by aggressive mixing and agitation should be avoided during processing as it contributes to the undesirable formation of randomly oriented, non-meat like fibers. Unidirectional and parallel fibers can only be formed through extruding and stretching under none turbulent, or laminar, conditions. Laminar flow condition occurs under low velocities where the fluid in question flows smoothly with overlapping layers, and it is characterized by having a Reynold number of less than 2040. Stretching of the meat analog would take place simultaneously during the extrusion. Ideally, the amount of linear expansion of the protein dough should be around 50% in either direction.

Fiber spinning method is not commonly used to produce meat analogs due to its complexity, and it also negates one of the key advantages of meat analogs. This method of production increases the cost of production, which eliminates the advantage of creating an inexpensive meat/protein substitute. The fiber spinning techniques were adopted from the spun fiber method used to create synthetic fibers in the textile industry. In general, fibers are made through creating filaments out of the protein used as the starting material. The process begins through the dispersion of proteins into a dispersing medium such as an alkaline aqueous solution. This dispersion is then fed through a spinneret, a device used to extrude a polymer solution to form fibers, and deposited into an acidic salt solution with a pH range of 5.6 to 6.4 for coagulation. The filaments after exiting the small die of the spinneret would have a diameter of around 0.003 inches. These filaments are then stretched and elongated until the average thickness is around 20 microns.

Excess salt solution is then removed from the fibers through squeezing or centrifuging prior to further processing. After the drying process, edible binders such as proteins, starches, cereals, dextrins, carboxy methyl cellulose, or a combination of them, are added to keep the fibers physically tied together through functioning as an adhesive or serving as a matrix in which the fibers embed upon. The fibers are then passed through a bath of melted fat and proceed to be pressed together to form the final product. The meat analog is then cut into suitable length for either packaging and distribution or further processing.

Citri-Fi's benefits in vegan meats include: fat binding to reduce greasiness when oil is added, reduction of saturated fats via solidification of oils instead of using solid fats, formation of meltable emulsion gels, adding texture via texturized Citri-Fi, and even can be part of the solution to replace methylcellulose.

The goal of most vegan meats is to mimic the taste and texture of real beef, pork, turkey, chicken, etc. based meats. However, most meat alternatives in accomplishing this challenge of duplicating the taste and texture of real meats. The problems with current solutions include:
1) Juiciness: Many current plant-based foods are either mushy or if they are firm, they tend to be dry. The reason is because plant proteins, whether texturized or not, tend to soften when they are hydrated and/or heated. Thus, formulators will tend to minimize the amount of water added to the formula, which makes the vegan meat dry. Or if water is added in sufficient amounts, the final vegan meats products tends to become mushy as the proteins break down with time and heat.
2) Greasiness: Adding oils and fats to vegan meats helps to bring a desirable taste and texture to vegan products by enhancing mouthfeel. Usually as much oil and fat is added as possible to the point where free fat and oil pools form. Because the vegan meats and plant proteins used tend to lack natural emulsification properties, there is a limit to how much fat or oil can be added before the meats start becoming greasy.
3) Saturated fats: Because liquid oils would freely flow out of the vegan meats and not stay in place during manufacturing, cooking, and storage, solid fats tend to be used more than liquid oils. However, the issue with using solid fats is their high saturated fat content. Two of the more common fats used in meat alternatives are coconut oil and palm fat, which typically are 85% and 50% saturated fat, respectively.
4) Firmness: With heat, many plant based proteins tend to soften and lose their firmness. However, this is the opposite occurrence of what happens with real beef based ground meat, which tends to firm with heating. Therefore, often methylcellulose is used because of its thermogelling property to bring back firmness to plant based meats, especially during heating. However, one known issue with methylcellulose is that although it firms when heated, it softens and loses structure when it cools. Thus, when vegan meats containing methylcellulose cool, frequently they lose their firmness and become mushy.
5) Coarseness: Most coarsely ground red meat products, e.g. bratwurst, sausage, hamburgers, etc., contain coarseness to them as they are not ground until they have a smooth texture. If they were ground so a smooth texture, they would be considered something closer to an emulsified hot dog like structure that doesn't have a coarse bounce and bite to them as they are chewed. This is a property currently lacking in many meat alternative products but is included as a subject in the present invention: coarse texturized citrus fiber.

### SUMMARY OF THE INVENTION

The present invention enables formation of coarse refined cellulose fibers that can efficiently improve texture of meat analogs (meatless edible mass) and be converted into gels and used in a vegan protein mass with higher efficiency and without adversely impacting either taste of “mouth feel” of the meat analogs. The invention includes a method of forming an expanded volume, refined cellulose coarse fiber product: a) including at least 0.005% by weight pectin and b) having average diameters of 1,000 to 10,000 microns and c) having at least 30% by weight water retentivity/weight of refined cellulose coarse fiber product including: providing a mass of raw citrus pulp with water to at least 10% up to 200% by weight water/pulp, (at this stage, an optional, but preferred pectin crosslinking enzyme (pectinesterases such as pectinmethylesterase);

heating the mass of raw citrus pulp with water at 90+ C and holding the raw citrus pulp with heating for more than 30 minutes to form an expanded fiber structure,
cooling the expanded fiber structure to about a cooled temperature of from 30-50° C., forming a coarse refined cellulose fiber, forming a reactive mixture,
holding the reactive mixture for at least about 30 minutes at 30-50° C., thereby crosslinking pectin by intraparticle pectin crosslinking of the coarse fiber to make the coarse fiber swell up and be firm,
drying the coarse fiber after swelling, and
deagglomerating the refined cellulose coarse fiber product to form the expanded volume, refined cellulose coarse fiber product.

The coarse fibers have average lengths of diameters of over 1000 microns as compared to typical high quality, highly refined, fine cellulose fibers of <700 microns or less than 600 microns. The refined cellulose fibers of the invention (coarse or fine) may be blended with alginate and edible vegan oil to form gels, especially when triggered with acid conditions that crosslink the alginate into a stable vegan gel supported by the coarse refined cellulose of the present technology.

### BRIEF DESCRIPTION OF THE FIGURES

FIG. 1 shows a graphic Comparison of Texture Analyzer Analysis of Plant-based Meats.

FIG. 2 shows a graphic representation of released moisture as related to the Highly Refined Cellulose fibers of the present invention.

FIG. 3 shows a graphic representation of released liquid in relation to the use of vegan oils in combination with the Highly Refined Cellulose fibers of the present invention.

### DETAILED DESCRIPTION OF THE INVENTION

One aspect of an Invention within the scope of the present technology includes: Coarse texturized citrus fiber is manufactured by lightly milling citrus based fibers, e.g., orange, lemon, or lime peel, but not to the point they that are fine (according to size ranges defined herein). The particle size of the Coarse texturized citrus fiber should be greater than 1 millimeter in size. All prior commercial types of Citri-Fi™ fibers have been less than 600μ (microns) in particle size and the more common types of Citri-Fi are less than 100 microns in particle size. However, with coarse texturized citrus fiber of the present invention, having a larger particle size is desirable.

The invention includes a method of forming an expanded volume, refined cellulose coarse fiber product: a) including at least 0.005% by weight pectin and b) having average diameters of 1,000 to 10,000 microns and c) having at least 30% by weight water retentivity/weight of refined cellulose coarse fiber product including: providing a mass of raw citrus pulp with water to at least 10% up to 200% by weight water/pulp, (at this stage, an optional, but preferred pectin crosslinking enzyme (pectinesterases such as pectinmethylesterase);

heating the mass of raw citrus pulp with water at 90+C and holding the raw citrus pulp with heating for more than 30 minutes to form an expanded fiber structure,
cooling the expanded fiber structure to about a cooled temperature of from 30-50° C., forming a coarse refined cellulose fiber, forming a reactive mixture,
holding the reactive mixture for at least about 30 minutes at 30-50° C., thereby crosslinking pectin by intraparticle pectin crosslinking of the coarse fiber to make the coarse fiber swell up and be firm,
drying the coarse fiber after swelling, and
deagglomerating the refined cellulose coarse fiber product to form the expanded volume, refined cellulose coarse fiber product.

The invention includes a method of forming an expanded volume, refined cellulose coarse fiber product: a) including at least 0.005% by weight pectin and b) having average diameters of 1,000 to 10,000 microns and c) having at least 30%, at least 40% at least 50%, and preferable 75-85% (for example about 80%) by weight water retentivity/weight of refined cellulose coarse fiber product including:

providing a mass of raw citrus pulp with water to at least 10% up to 200% by weight water/pulp,
heating the mass of raw citrus pulp with water at 90+C and holding the raw citrus pulp with heating for more than 30 minutes to form an expanded fiber structure,
cooling the expanded fiber structure to about a cooled temperature of from 30-50° C., forming a coarse refined cellulose fiber adding enzyme to the coarse refined cellulose to form a reactive mixture,
holding the reactive mixture for at least about 20 or 30 minutes, preferable 45-75 minutes and for example one hour at 30-50° C., thereby crosslinking pectin by intraparticle pectin crosslinking of the coarse fiber to make the coarse fiber swell up and be firm,
drying the coarse fiber after swelling, and
deagglomerating the refined cellulose coarse fiber product to form the expanded volume, refined cellulose coarse fiber product.

Particle size is only one of the requirements of making the coarse texturized citrus fiber (abbreviated TCF in the formulas below). The next desired property is firmness while being succulent to combat mushiness commonly found in meat analogs made with texturized vegetable proteins. The firmness and succulence refer to the product being juicy when chewed on yet has a firm bite strength and coarseness that closely resembles ground beef. The properties of firmness and succulence is a property common to many fresh fruits and vegetables before enzymatic and microbial breakdown causes them to deteriorate and become mushy.

In the practice of the present invention, the TVP (total volume of protein) provided by the exclusively non-meat-containing mass should be at least 10%, at least 25% by weight, at least 35% by weight or at least 40% by weight protein content of the total solids mass of the composition, with up to 90% (as with the soy protein isolate). There are many vegetarian sources of protein available for use in the practice of the present invention. The following discussion expands on those sources.

Seitan comes from wheat gluten. The production process removes the starch from the wheat, usually by rinsing it with water. This process leaves behind a protein dense food that has a texture similar to that of chicken and a mild taste. Textured vegetable proteins such as those sourced from peas, legumes, beans (pinto, lima, black beans, etc, as non-limiting examples), lentils, chickpeas, quinoa, buckwheat, oats, barley, rye, wheat, corn, and mushrooms are used in the practice of the present invention.

The additional keys to making the firmness with succulence is an enzymatic treatment of the citrus fibers during processing to cross link native pectin structures internally such that the pectin inside the large particles cross link with each other to form firmness and succulence. If the citrus fibers had a small particle size, the pectins of the particle would cross link with each other from other particles, which could increase viscosity and/or form a gel.

Once the treated citrus fibers are cross linked and made firm with succulence, they then can be dried using any common means and will readily rehydrate. When these are incorporated into plant based or any type of meat product, they add coarseness that is often times missing when looking for the texture of a beef-based ground meat or similar red meat product.

A second aspect of an Invention within the scope of the present technology includes: Gelation

The formation of a gel can be advantageous in plant-based foods to reduce the amount of free water and oil available for softening making texturized vegetable proteins mushy. Yet having the liquids available to provide overall juiciness when the plant-based foods are heated and consumed, which is typical and expected of meat products, is desirable to form a great-tasting product. These gels may contain fats or oils as well to improve lubricity and the fat like mouthfeel expected when consuming real meats. Another desirable property of these gels is that they melt when heated so that the juices release and provide juiciness when heated. Several methods can be used to form these emulsion gels, including: 1) Citri-Fi alone using oil, water, and a cross linking enzyme. Alternatively, 2) using Citri-Fi and sodium alginate, which will gel together as a result of the native pectin in Citri-Fi once the pH is lowered to less than 3.5. A significant benefit of the Citri-Fi and alginate gel system is that the alginate is not cross linked with calcium and the gel can be made thermal reversible so it melts when heated. The preferred enzymes are pectin-crosslinking enzymes that assist in improving the degree of pectin crosslinking (which can occur in the processes of the present invention to a limited degree with heating). The most preferred enzymes are pectin methyl enzymes. These materials are commercially available, as from Creative Enzymes, Shirley, N.Y. as Catalogue No. FJE-1428, as Pectin Methylesterase. Other similar materials include pectinesterase from alternative biological sources such as orange peel and Streptomyces avermitilis MA-4680.

A third aspect of an Invention within the scope of the present technology includes: Additionally, locking up oils in the gels can provide the product with the appearance of a solid fat.

Because of Citri-Fi's emulsification properties, it can be used to solidify liquid oils even if a gel isn't formed. This can be done making a mixture containing 50% liquid oil or less, 50% water or more, and 0.1% or more of Citri-Fi™ fibers The ratios of these combinations can be adjusted to attain the viscosity desired to best mimic a solid fat. The Citri-Fi solidifies and emulsifies the liquid oils, which contain little or no saturated fats. And presently in plant-based foods, high amounts of coconut oils and palm fats are used because of their solid like texture to help counteract mushiness and greasiness in the final product but this has been found to be an important and novel use of using Citri-Fi™ fiber.

The aspects of the invention include in more detailed the following:

One method forms an expanded volume, refined cellulose coarse fiber product including at least 0.005% by weight pectin and having average diameters of 1,000 to 10,000 microns and at least 30% by weight water retentivity/weight of fiber product including:

providing a mass of raw citrus pulp with water to at least 10% up to 200% weight water/pulp, heat at 90+ C and hold for more than 30 minutes to form an expanded fiber structure, c) cool the expanded fiber structure to about 40 C, forming a coarse refined cellulose fiber d) add enzyme to form reactive mixture, e) hold the reactive mixture for one hour at about 40 C, crosslinking pectin by intraparticle pectin cross linking the coarse fiber to make the coarse fiber swell up and be firm, f) heat inactivate the enzymatically treated fiber mass and dry the coarse fiber after swelling, g) and deagglomerating the refined cellulose coarse fiber product.

Another method forms a vegan gel comprising by mixing as follows 100 parts by total weight:

provide 2-6 parts by weight highly refined coarse cellulose fiber;
add 0.75-4 parts by weight alginate to the highly refined coarse cellulose fiber and add 20-50 parts by weight edible vegan oil;
solubilize an acid in water; and
add the acid in water to the combination of the alginate and the highly refined coarse cellulose fiber to attain a pH of between 3-3.4 with mixing to form the edible vegan gel.

The method includes optionally adding calcium along with the alginate. The calcium is optionally added as 0.001-0.2 parts of the 100 parts by weight. The alginate and highly refined coarse cellulose fiber may be added to the edible vegan oil. The edible vegan oil is derived from natural products selected from the group consisting of grains, fruits and vegetables. The edible vegan gel does not form a liquid when heated to 40 C.

The coarse refined cellulose fibers and the gels may be used in forming faux-meat, or vegan “meat” or protein masses such as patties, chunks, meal and the like.

### Example 1: Emulsion Gel Using Citri-Fi and Sodium Alginate

In this example, gels can be made with alginate and Citri-Fi that remain fluid when melted even after being cooled to about 100° F. This is meltability property important to have a fat-like taste and texture in vegan products. Below a photo of the gel that made using the following formula and process:
1) Add 0.9% alginate, 1.5% Citri-Fi 100FG, and 30% soybean oil. Mix well together to disperse the alginate and Citri-Fi. This mixture is very fluid.
2) Add 54.08% water and mix well. Some viscosity will develop but it no gel will form.
3) After forming an emulsion, add 13.52% of a citric acid solution (5% concentration, 0.676 g citric acid and 12.84 g water) until pH reaches 3.4.
4) Mix briefly and a gel will form immediately.

Upon heating, the gel will melt:

### Example 2: Emulsion Gel Using Citri-Fi and Sodium Alginate

1) Add 1.8% alginate, 1.1% Glucono delta-lactone, 3.0% Citri-Fi 100FG, and 50% soybean oil. Mix well together to disperse the alginate and Citri-Fi. This mixture will be very fluid with low viscosity.
2) Add 54.08% water and mix well. Some viscosity will develop but it no gel will form.
3) The mixture will be very fluid with low viscosity for several minutes or hours until the GDL is given time to disassociate and gradually lower the pH.
4) A solid gel will form after several hours.

### Example 3: Emulsion Gels Various Levels of Ingredients Containing Citri-Fi and Sodium Alginate

Gel strength (in grams, or g) of gels made using various levels of Citri-Fi, alginate, GDL were measured using a texture analyzer available from Texas Instruments. The results are shown below:

| | % | % | % | % | % | % | % | % | % |
|---|---|---|---|---|---|---|---|---|---|
| Citri-Fi | 1.5 | 1.5 | 1 | 2 | 1.5 | 1.5 | 1.5 | 1.5 | 1.5 |
| 100 FG | | | | | | | | | |
| Alginate | 0.9 | 0.9 | 0.9 | 0.9 | 1.2 | 1.5 | 0.9 | 0.9 | 0.9 |
| GDL | 1.1 | 1.5 | 1.1 | 1.1 | 1.1 | 1.1 | 1.1 | 1.1 | 1.1 |
| CaSO4•2H2O | 0 | 0 | 0 | 0 | 0 | 0 | 0 | 0.1 | 0 |
| Canola | 30 | 30 | 30 | 30 | 30 | 30 | 22.5 | 30 | 40 |
| Palm | 0 | 0 | 0 | 0 | 0 | 0 | 7.5 | 0 | 0 |
| Water | 66.5 | 66.1 | 67 | 66 | 66.2 | 65.9 | 66.5 | 66.4 | 56.5 |
| Gel Strength, g | 80.5 | 96 | 78 | 92.5 | 85.5 | 87 | 80.5 | 155.5 | 76 |

### Example 4: Emulsion Gel that has been Enzymatically Treated

1) Add 3.0% Citri-Fi 100FG and 30% oil, mix well.
2) Dilute 1% pectin methyl esterase enzyme in water
3) Adding enzyme solution quickly into the oil phase during mixing. Mix 5-10 seconds to get homogeneous emulsion.
4) Ideally, store the emulsion at 45° C. for 20 mins. Or store at room temperature for over 3 hours.

### Gel Strength

### Example 5: Production of Coarse Texturized Citrus Fiber

Mill citrus peel citrus fibers using a hammer mill using a ⅜″ screen, 2) Heat the citrus fibers at 90 C or above for one hour, adjusting moisture content to 50-90% moisture, 3) cool the solution down to 40 C, 4) Add 0.2% pectin methyl esterase enzyme, 5) Optional: add 0.02% calcium source, 6) hold for one hour, 7) dry using fluid bed or other type of dryer, 8) deagglomerate using milling to final desired particle size. 9) When ready to incorporate into a formula, rehydrate the dried coarse texturized fiber (TCF) using 2-4 parts water to one part TCF and allow to sit for 10 minutes. The product is then ready to be used to provide coarseness, bite, and texture to meat products.

### Example 6: A Plant Based Meat Formula

| | Control | TCF Fiber |
|---|---|---|
| Soy texturized vegetable | 45 | 40 |
| protein (TVP) | | |
| Coarse texturized citrus | 0 | 17.5 |
| fiber TCF - hydrated to | | |
| 70% moisture content | | |
| Yeast Ext | 2.9 | 2.9 |
| Sea Salt | 1.5 | 1.5 |
| Water | 35.3 | 22.8 |
| Beet Juice Powder | 0.5 | 0.5 |
| Water (room temp) | 10 | 10 |

### Procedure:

1) Hydrate the TVP in boiling water along with salt, calcium and yeast extract.
2) Allow 10 minutes to absorb water
3) Process in bowl chopper for 2 minutes.
4) Pre-dissolve beet powder in water at room temperature and add to mixture while processing in the bowl chopper.
5) Add seasoning then add binders.

Results: TCF helps to firm the burger and create improved bite, coarseness, and bounce to the meat. The ideal rate is between 1-15% TCF hydrated.

One important aspect of the present technology is the ability to produce larger size highly refined cellulose fiber materials. In the normal process to make Citri-Fi® fibers, steps include: a) forming a fine (less that 700 micron) particle size using intense milling to attain the small size, b) adding water (if needed for pumping), heating to pasteurize the material, c) high speed shearing, e.g., to homogenize the material and further reduce particle sizes and to expand surface area, d) and then adding pectin, and e) drying the material, f) forming a final Citri-Fi® particle or fiber having a number average particle size that is small, always less than 600 microns.

In addressing aspects of the present invention, an enzyme treatment, using pectin methyl esterase can be added to this normal process listed above either in the middle steps after pasteurization or at the end on the final product to increase viscosity, as outlined in U.S. Pat. No. 8,884,002 (Lundberg) which evidences that pectinases, such as Pectinex™ Ultra SP-L (composed of the enzyme Polygatacturonase, a type of pectinase which is derived from Aspergillus aculeatus) or pectinmethylesterases were used to decrease or increase, respectively, the viscosity of fiber solutions, especially solutions with highly refined cellulosic thickeners, and particularly those made of highly refined cellulosic parenchyma cell wall fiber solutions. The enzyme can reduce the viscosity up to 95% or increase the viscosity 100 fold. At lower concentrations the enzyme requires up to a few days of reacting to reach the full reduction in viscosity. Pectinex™ Ultra SP-L has an optimum pH of 4.5-5 and a temperature optimum of 40 C. By controlling the viscosity available from the dried, treated highly refined cellulosic fiber compositions, tailored powder compositions can be provided that will provide precise viscosities when rehydrated in solutions at a constant concentration.

Adding enzymes to the small particles crosslinks the smaller fibers and connects them such that a gel or high viscosity solution forms. Done this way, the linkages formed between different particles could be termed interparticle pectin cross linking.

The process for making Coarse texturized citrus fibers is different from the process described above and when previously used in the manufacture of Citri-Fi™ fiber products. Note that high speed shear can't be used to make a large particle sized product as it would reduce particle size. This would not be good within the scope of the present technology, and also would encourage interconnecting bonds forming between different particles, which is also undesirable.

The new process includes: a) particle size, simple low intensity milling to form a large size, b) add moisture as needed, heat at 90+C and hold for more than 30 minutes to expand fiber structure, (no shear is used as it isn't needed plus it would also reduce particle size), c) cool to 40 C, d) add enzyme & optionally calcium, e) hold one hour at 40 C—this cross links pectin within (intraparticle pectin cross linking) the coarse fiber to make it swell up and be firm, f) dry, g) deagglomeration with minimum milling.

In greater detail, the new process that produces the newer larger volume, larger diameter highly refined cellulose fibers includes: a) using raw citrus pulp fiber in a simple, low intensity milling to form a large size (1000 microns to 10,000 microns, preferably 1000 to 5000 microns, and more preferably from 2000 to 8000 microns), b) add moisture as needed to the raw citrus pulp, heat at 90+ degrees C., (for example 90-98 C) and hold for more than 30 minutes to expand fiber structure by 8-60%, preferably 10-50% by volume, without using high shear (even no substantive shear is used as it isn't needed, thereby forming expanded (highly refined cellulose fiber) in water mixture) as it would also reduce particle size), cool the mixture to 40 C, d) add enzyme and optionally calcium (as 0.3 to 1.5% by weight, enzyme (preferably from 0.5 to 0.9% by weight) and 1-5% calcium, preferably from 2-4% by weight calcium/fiber, e) hold one hour at 40 C—this cross links pectin within (intraparticle pectin cross linking, usually from 5-60% crosslinking is provided in the coarse fiber to make it swell up and be firm, f) dry, g) deagglomeration (as with tumbling or light milling) with minimum milling.

The final dried product may be present in the final food products as from 1-60% by weight, preferably from 5-50% by weight along with (preferably) other vegan materials. A further summary of the technology can include:

### Alginate-Citri-Fi Emulsion Gel Procedure:

1) Add alginate and Citri-Fi® fiber 100FG to the oil. Mix well to form fiber-alginate mixture.
2) Solubilize an acid in the water
3) Add acid solution (pH will reach 3-3.4) in the acidified Citri-Fi® fiber alginate mixture.
4) Mix briefly and gel will form when pH reaches final range.
5) Store the gel at room temperature for over 3 hours to stabilize any interactive chemical activity.

This can be further summarized as:

Emulsion Gel Test Summary Compositions with Small (<600 micron fibers)

### Results (All Components Indicated by Percentages of the Total Composition)

Citri-Fi® 100FG Fibers 2-6%, preferably 2.5-5%, 3% used in sample
Sodium Alginate 0.75-4, 1.0-2.5 1.8% used in example
Acid (e.g., Glucono-Delta Lactone) 0.5-3.5, 0.80-2.0, 1.1% used in example to attain a pH between 3 and 3.4. Any form of acid will work to gel the mixture, e.g. citric acid, tartaric acid, lactic acid, etc but a slower disassociating acid will help with the formation of a stronger gel network.
Oil (e.g., canola) 20-60%, 25-40%, 30% used in example.

### Water 27-76.75%.

### Major Oils

These oils make up a significant fraction of worldwide edible oil production. All are also used as fuel oils.
Coconut oil, a cooking oil, with medical and industrial applications as well. Extracted from the kernel or meat of the fruit of the coconut palm. Common in the tropics, and unusual in composition, with medium chain fatty acids dominant.
Corn oil, one of the principal oils sold as salad and cooking oil.
Canola oil, the most sold cooking oil all around the world, used as a salad and cooking oil, both domestically and industrially. Also used in fuel industry as bio-fuel.
Cottonseed oil, used as a salad and cooking oil, both domestically and industrially.
Olive oil, used in cooking, cosmetics, soaps, and as a fuel for traditional oil lamps.
Palm oil, the most widely produced tropical oil. Popular in West African and Brazilian cuisine. Also used to make biofuel.
Peanut oil (Ground nut oil), a clear oil with some applications as a salad dressing, and, due to its high smoke point, especially used for frying.
Rapeseed oil, including Canola oil, one of the most widely used cooking oils.
Safflower oil, until the 1960s used in the paint industry, now mostly as a cooking oil.
Sesame oil, cold pressed as light cooking oil, hot pressed for a darker and stronger flavor.
Soybean oil, produced as a byproduct of processing soy meal.
Sunflower oil, a common cooking oil, also used to make biodiesel.

### Nut Oils

Hazelnuts from the Common Hazel, Used to Make Hazelnut Oil

Nut oils are generally used in cooking, for their flavor. Most are quite costly, because of the difficulty of extracting the oil.
Almond oil, used as an edible oil, but primarily in the manufacture of cosmetics.
Beech nut oil, from Fagus sylvatica nuts, is a well-regarded edible oil in Europe, used for salads and cooking.
Brazil nut oil contains 75% unsaturated fatty acids composed mainly of oleic and linolenic acids, as well as the phytosterol, beta-sitosterol, and fat-soluble vitamin E. Extra virgin oil can be obtained during the first pressing of the nuts, possibly for use as a substitute for olive oil due to its mild, pleasant flavor.
Cashew oil, somewhat comparable to olive oil. May have value for fighting dental cavities.
Hazelnut oil, mainly used for its flavor. Also used in skin care, because of its slight astringent nature.
Macadamia oil, with a mild nutty flavor and a high smoke point.
Mongongo nut oil (or manketti oil), from the seeds of the Schinziophyton rautanenii, a tree which grows in South Africa. High in vitamin E. Also used in skin care.
Pecan oil, valued as a food oil, but requiring fresh pecans for good quality oil.
Pine nut oil, sold as a gourmet cooking oil, and of potential medicinal interest as an appetite suppressant.
Pistachio oil, a strongly flavored oil with a distinctive green color.
Walnut oil, used for its flavor, also used by Renaissance painters in oil paints.
Pumpkin seed oil

### Citrus Oils

A number of citrus plants yield pressed oils. Some, such as lemon and orange oil, are used as essential oils, which is uncommon for pressed oils. The seeds of many if not most members of the citrus family yield usable oils.
Grapefruit seed oil, extracted from the seeds of grapefruit (Citrus x paradisi). Grapefruit seed oil was extracted experimentally in 1930 and was shown to be suitable for making soap.
Lemon oil, similar in fragrance to the fruit. One of a small number of cold pressed essential oils. Used as a flavoring agent and in aromatherapy.
Orange oil, like lemon oil, cold pressed rather than distilled. Consists of 90% d-Limonene. Used as a fragrance, in cleaning products and in flavoring foods.

The fruit of the sea-buckthorn

Oils from Melon and Gourd Seeds

Watermelon seed oil, extracted from the seeds of Citrullus vulgaris, is used in cooking in West Africa.

Members of the Cucurbitaceae include gourds, melons, pumpkins, and squashes. Seeds from these plants are noted for their oil content, but little information is available on methods of extracting the oil. In most cases, the plants are grown as food, with dietary use of the oils as a byproduct of using the seeds as food.
Bitter gourd oil, from the seeds of Momordica charantia. High in α-Eleostearic acid. Of current research interest for its potential anti-carcinogenic properties.
Bottle gourd oil, extracted from the seeds of the Lagenaria siceraria, widely grown in tropical regions. Used as an edible oil.
Buffalo gourd oil, from the seeds of the Cucurbita foetidissima, a vine with a rank odor, native to southwest North America.
Butternut squash seed oil, from the seeds of Cucurbita moschata, has a nutty flavor that is used for salad dressings, marinades, and sautéeing.
Egusi seed oil, from the seeds of Cucumeropsis mannii naudin, is particularly rich in linoleic acid.
Pumpkin seed oil, a specialty cooking oil, produced in Austria, Slovenia and Croatia. Used mostly in salad dressings.
Watermelon seed oil, pressed from the seeds of Citrullus vulgaris. Traditionally used in cooking in West Africa.

### Food Supplements

A number of oils are used as food supplements (or “nutraceuticals”), for their nutrient content or purported medicinal effect. Borage seed oil, blackcurrant seed oil, and evening primrose oil all have a significant amount of gamma-Linolenic acid (GLA) (about 23%, 15-20% and 7-10%, respectively), and it is this that has drawn the interest of researchers.
Açaí oil, from the fruit of several species of the Açaí palm (Euterpe) grown in the Amazon region.
Black seed oil, pressed from Nigella sativa seeds, has a long history of medicinal use, including in ancient Greek, Asian, and Islamic medicine, as well as being a topic of current medical research.
Blackcurrant seed oil, from the seeds of Ribes nigrum, used as a food supplement. High in gamma-Linolenic, omega-3 and omega-6 fatty acids.
Borage seed oil, from the seeds of Borago officinalis.
Evening primrose oil, from the seeds of Oenothera biennis, the most important plant source of gamma-Linolenic acid, particularly because it does not contain alpha-Linolenic acid.
Flaxseed oil (called linseed oil when used as a drying oil), from the seeds of Linum usitatissimum. High in omega-3 and lignans, which can be used medicinally. A good dietary equivalent to fish oil. Easily turns rancid.

### Other Edible Oils

### Carob Seed Pods, Used to Make Carob Pod Oil

Amaranth oil, from the seeds of grain amaranth species, including Amaranthus cruentus and Amaranthus hypochondriacus, high in squalene and unsaturated fatty acids.
Apricot oil, similar to almond oil, which it resembles. Used in cosmetics.
Apple seed oil, high in linoleic acid.
Argan oil, from the seeds of the Argania spinosa, is a food oil from Morocco developed through a women's cooperative founded in the 1990s, that has also attracted recent attention in Europe.
Avocado oil, an edible oil used primarily in the cosmetics and pharmaceutical industries. Unusually high smoke point of 510° F. (266° C.).
Babassu oil, from the seeds of the Attalea speciosa, is similar to, and used as a substitute for, coconut oil.
Ben oil, extracted from the seeds of the Moringa oleifera. High in behenic acid. Extremely stable edible oil. Also suitable for biofuel.
Borneo tallow nut oil, extracted from the fruit of species of genus Shorea. Used as a substitute for cocoa butter, and to make soap, candles, cosmetics and medicines in places where the tree is common.
Cape chestnut oil, also called yangu oil, is a popular oil in Africa for skin care.
Carob pod oil (Algaroba oil), from carob, with an exceptionally high essential fatty acid content.
Cocoa butter, from the cacao plant, is used in the manufacture of chocolate, as well as in some ointments and cosmetics; sometimes known as theobroma oil
Cocklebur oil, from species of genus Xanthium, with similar properties to poppyseed oil, similar in taste and smell to sunflower oil.
Cohune oil, from the Attalea cohune (cohune palm) used as a lubricant, for cooking, soapmaking and as a lamp oil.
   Coriander seeds are the source of an edible pressed oil, Coriander seed oil.
Coriander seed oil, from coriander seeds, used in a wide variety of flavoring applications, including gin and seasoning blends. Recent research has shown promise for use in killing food-borne bacteria, such as E. coli.
Date seed oil, extracted from date pits. Its low extraction rate and lack of other distinguishing characteristics make it an unlikely candidate for major use.
Dika oil, from Irvingia gabonensis seeds, native to West Africa. Used to make margarine, soap and pharmaceuticals, where is it being examined as a tablet lubricant. Largely underdeveloped.
False flax oil made of the seeds of Camelina sativa. One of the earliest oil crops, dating back to the 6th millennium B.C. Produced in modern times in Central and Eastern Europe; fell out of production in the 1940s. Considered promising as a food or fuel oil.
Grape seed oil, a cooking and salad oil, also sprayed on raisins to help them retain their flavor.
Hemp oil, a high quality food oil also used to make paints, varnishes, resins and soft soaps.
Kapok seed oil, from the seeds of Ceiba pentandra, used as an edible oil, and in soap production.
Kenaf seed oil, from the seeds of Hibiscus cannabinus. An edible oil similar to cottonseed oil, with a long history of use.
Lallemantia oil, from the seeds of Lallemantia iberica, discovered at archaeological sites in northern Greece.
Mafura oil, extracted from the seeds of Trichilia emetica. Used as an edible oil in Ethiopia. Mafura butter, extracted as part of the same process when extracting the oil, is not edible, and is used in soap and candle making, as a body ointment, as fuel, and medicinally.
Marula oil, extracted from the kernel of Sclerocarya birrea. Used as an edible oil with a light, nutty flavor. Also used in soaps. Fatty acid composition is similar to that of olive oil.
Meadowfoam seed oil, highly stable oil, with over 98% long-chain fatty acids. Competes with rapeseed oil for industrial applications.
Mustard oil (pressed), used in India as a cooking oil. Also used as a massage oil.
Niger seed oil is obtained from the edible seeds of the Niger plant, which belongs to the genus Guizotia of the family Asteraceae. The botanical name of the plant is Guizotia abyssinica. Cultivation for the plant originated in the Ethiopian highlands, and has since spread from Malawi to India.

Poppy seeds, used to make poppyseed oil
Nutmeg butter, extracted by expression from the fruit of cogeners of genus Myristica. Nutmeg butter has a large amount of trimyristin. Nutmeg oil, by contrast, is an essential oil, extracted by steam distillation.
Okra seed oil, from Abelmoschus esculentus. Composed predominantly of oleic and linoleic acids. The greenish yellow edible oil has a pleasant taste and odor.
Papaya seed oil, high in omega-3 and omega-6, similar in composition to olive oil. Not to be confused with papaya oil produced by maceration.
Perilla seed oil, high in omega-3 fatty acids. Used as an edible oil, for medicinal purposes in Asian herbal medicine, in skin care products and as a drying oil.
Persimmon seed oil, extracted from the seeds of Diospyros virginiana. Dark, reddish-brown color, similar in taste to olive oil. Nearly equal content of oleic and linoleic acids.
Pequi oil, extracted from the seeds of Caryocar brasiliense. Used in Brazil as a highly prized cooking oil.
Pili nut oil, extracted from the seeds of Canarium ovatum. Used in the Philippines as an edible oil, as well as for a lamp oil.
Pomegranate seed oil, from Punica granatum seeds, is very high in punicic acid (which takes its name from pomegranates). A topic of current medical research for treating and preventing cancer.
Poppyseed oil, long used for cooking, in paints, varnishes, and soaps.
Pracaxi oil, extracted from the seeds of Pentaclethra macroloba. Similar to peanut oil, but has a high concentration of behenic acid (19%).

### Virgin Pracaxi Oil

Prune kernel oil, marketed as a gourmet cooking oil Similar in composition to peach kernel oil.
Quinoa oil, similar in composition and use to corn oil.
Ramtil oil, pressed from the seeds of the one of several species of genus Guizotia abyssinica (Niger pea) in India and Ethiopia.
Rice bran oil is a highly stable cooking and salad oil, suitable for high-temperature cooking. It also has potential as a biofuel.
Royle oil, pressed from the seeds of Prinsepia utilis, a wild, edible oil shrub that grows in the higher Himalayas. Used medicinally in Nepal.
Shea nuts, from which shea butter is pressed
Sacha inchi oil, from the Peruvian Amazon. High in behenic, omega-3 and omega-6 fatty acids.
Sapote oil, used as a cooking oil in Guatemala.
Seje oil, from the seeds of Jessenia bataua. Used in South America as an edible oil, similar to olive oil, as well as for soaps and in the cosmetics industry.
Shea butter, much of which is produced by poor, African women. Used primarily in skin care products and as a substitute for cocoa butter in confections and cosmetics.
Taramira oil, from the seeds of the arugula (Eruca sativa), grown in West Asia and Northern India. Used as a (pungent) edible oil after aging to remove acridity.
Tea seed oil (Camellia oil), widely used in southern China as a cooking oil. Also used in making soaps, hair oils and a variety of other products.
Thistle oil, pressed from the seeds of Silybum marianum. A good potential source of special fatty acids, carotenoids, tocopherols, phenol compounds and natural anti-oxidants, as well as for generally improving the nutritional value of foods.
Tigernut oil (or nut-sedge oil) is pressed from the tuber of Cyperus esculentus. It has properties similar to soybean, sunflower and rapeseed oils. It is used in cooking and making soap and has potential as a biodiesel fuel.
Tobacco seed oil, from the seeds of Nicotiana tabacum and other Nicotiana species. Edible if purified.
Tomato seed oil is a potentially valuable by-product, as a cooking oil, from the waste seeds generated from processing tomatoes.
Wheat germ oil, used nutritionally and in cosmetic preparations, high in vitamin E and octacosanol.

The acids used here are preferably lactones, wherein lactones are cyclic carbocyclic esters, containing a 1-oxacycloalkan-2-one structure (—(C═O)—O—), or analogues having unsaturation or heteroatoms replacing one or more carbon atoms of the ring. The most stable structure for lactones are the 5-membered γ-lactones and 6-membered δ-lactones because, as in all organic cycles, 5 and 6 membered rings minimize the strain of bond angles. γ-lactones are so stable that, in the presence of dilute acids at room temperature, 4-hydroxy acids (R—CH(OH)—(CH₂)₂—COOH) immediately undergo spontaneous esterification and cyclisation to the lactone. β-lactones do exist, but can only be made by special methods. α-lactones can be detected as transient species in mass spectrometry experiments. Di-lactones may also be used in the practice of the present technology as the acid component described above.

### Gluten Replacement Case Study:

### Preparation of Meat Alternative Patty

The below formulation and methods within the invention were used to compare patties with Citri-Fi™ TX10 using no gluten versus otherwise similar or identical patties with gluten.

### Preparation of Meat Alternative Patty

TABLE 1
Meat Alternative Patty Formulation

| | 0% | | | | | |
|---|---|---|---|---|---|---|
| | Citri-Fi | 1% | 2% | 4% | 6% | 8% |
| | TX10 (8% | Citri-Fi | Citri-Fi | Citri-Fi | Citri-Fi | Citri-Fi |
| | Gluten) | TX10 | TX10 | TX10 | TX10 | TX10 |
| Ingredients | (%) | (%) | (%) | (%) | (%) | (%) |
| Protein | 22 | 22 | 22 | 22 | 22 | 22 |
| Citri-Fi | 0 | 1 | 2 | 4 | 6 | 8 |
| TX10 | | | | | | |
| Water 1 | 29 | 36 | 35 | 33 | 31 | 29 |
| Coconut Oil | 14 | 14 | 14 | 14 | 14 | 14 |
| Citri-Fi | 1 | 1 | 1 | 1 | 1 | 1 |
| 100FG | | | | | | |
| Water 2 | 26 | 26 | 26 | 26 | 26 | 26 |
| Gluten | 8 | 0 | 0 | 0 | 0 | 0 |
| Total | 100 | 100 | 100 | 100 | 100 | 100 |

### Meat Patty Methods

The meat alternative patty was prepared with the formulation listed in Table 1. The same amount of Citri-Fi TX10 was used to replace gluten for comparison. The specific procedure is listed as follows:
1. Dry blend texturized vegetable pea protein (TVP) and Citri-Fi TX10.
2. Hydrate the TVP and Citri-Fi TX10 with boiling Water 1 for 10 minutes.
3. Disperse Citri-Fi 100FG in the warm coconut (or other vegetable oil, fruit oil) oil (approximately 85° F.) and mix well.
4. Add Water 2 to form a homogeneous emulsion under shearing.
5. Cool the emulsion immediately after being made.
6. For the patty with containing gluten, add dry gluten and mix well with the hydrated TVP.
7. Add solidified emulsion to the mixture and mix well.
8. Form 85 g patties in a 3 oz. round mold and store in refrigerator overnight.
9. Keep the patties under room temperature for 1 h and cook with a double side grill under 350° F. for 5 minutes.

### Results and Discussion

The mixture of hydrated TVP was compared against Citri-Fi TX10 with gluten was performed. The mix of TVP with Citri-Fi TX10 was viewed and weighed to indicate higher bulk density than the test containing gluten, which is likely because the Citri-Fi TX10 can adsorb more water than gluten. Thus, when Citri-Fi TX10 is added, the proteins cannot adsorb as much water as the test with gluten, which can be a way to reduce the TVP from getting overly soft and mushy. Moreover, the Citri-Fi TX10 contains a larger particle size than gluten, which helps to improve the meat like texture in the final cooked product,

A comparison of the meat alternative patties is shown. After the hydration, Citri-Fi TX10 adsorbs water and forms a sticky network to adhere or “glue” the protein matrix together. Compared with Citri-Fi TX10, gluten presents better viscoelastic property, which helps with binding. Additionally, the gluten-containing patty showed the presence of more free water, which is likely due to gluten's lower water absorption properties versus Citri-Fi TX10. Thus, just from physical handling of the patties it was noticeable that the patty containing gluten was weaker than the Citri-Fi TX10 patty at the same usage rate.

To quantify cold binding strength, the uncooked patties were tested by a texture analyzer using a TA18 round probe. The round probe was used for the compression load test. All patties were tested by compressing the patty with the probe reaching a depth of 10 mm. The compression load was recorded when the compression reached the peak value or at the depth of 10 mm.

With an increase of Citri-Fi concentration from 1% to 8%, the cold binding strength improved gradually, with the compression load rising from 872 g to 1,704 g. The compression of the patty containing 8% gluten was 962 g and it only took 2% Citri-Fi TX10 to attain a similar cold strength (969 g). Because Citri-Fi TX10 forms a sticky network to hold the proteins together and is a relatively large particulate, the network helps to link proteins together and provides strength. The meat alternative patty was cooked using a bench top double-sided sandwich grill at 350° F. for 5 minutes. Seasonings were not added in these tests to focus on the comparison of gluten versus Citri-Fi TX10. However, the seasonings should be added to a specific flavor that customers are seeking.

Once on the grill, the patties started sizzling at the beginning of the cooking, which was a result of the emulsion composition put into the patty. After 1-2 minutes, the sizzling effect reaches its peak after the free water was released from the patty. The taste of the final cooked patty was good and comparable for the various tests.

### CONCLUSIONS

In this experiment, at relatively low usage rates Citri-Fi TX10 was shown to be effective at replacing the cold binding strength of gluten. The Citri-Fi TX10 also appears to hold more water than gluten to help form a sticky network that hinds protein and helps to maintain TVP's hydrated firmness. The patty with Citri-Fi TX10 shows better formation and much higher compression strength when levels over 2% were used and cold strength increased as Citri-Fi usage rates increased. To match the cold strength of 8% gluten, only 2% Citri-Fi TX10 was needed. In addition, the cooked patty with Citri-Fi TX10 shows good taste and meat-like sizzling properties.

### Sizzling Effect Testing:

Background: Real meat products release significant amounts of liquid when they are cooked and produce a sizzling effect when placed on a pan.

### Objective

Seeking solutions to simulate the sizzling process of cooking a patty.

### Solutions:

Use CitriFi™ fibers CF100FG to make emulsion and release water & oil when heated.
Solidify the emulsion to minimize the protein and TX10 adsorb extra water from emulsion phase before cooking.

### Example 1

### Citri-Fi TX10 Usage Rate and Enzyme Treatment

### Formula

| | Citri-Fi TX10 Usage Rate | | | | | |
|---|---|---|---|---|---|---|
| Ingredients | 1% | 2% | 3% | 4% | 5% | 6% |
| Pea TVP | 22 | 22 | 22 | 22 | 22 | 22 |
| Citri-Fi | 1 | 2 | 3 | 4 | 6 | 8 |
| TX10 | | | | | | |
| Water 1 | 20 | 20 | 20 | 20 | 20 | 20 |
| Coconut Oil | 14 | 14 | 14 | 14 | 14 | 14 |
| Citri-Fi | 1 | 1 | 1 | 1 | 1 | 1 |
| 100FG | | | | | | |
| Water 2 | 26 | 26 | 26 | 26 | 26 | 26 |
| Calcium | 0.06 | 0.09 | 0.12 | 0.15 | 0.21 | 0.27 |
| Sulfate | | | | | | |
| Enzyme | 1 | 1 | 1 | 1 | 1 | 1 |
| Water 3 | 14.94 | 13.91 | 12.88 | 11.85 | 9.79 | 7.73 |
| Total | 100 | 100 | 100 | 100 | 100 | 100 |

### Procedure:

1. Dry blend texturized vegetable pea protein (TVP) and Citri-Fi TX10.
2. Hydrate the TVP and Citri-Fi TX10 with boiling Water 1 for 10 minutes.
3. Disperse Citri-Fi 100FG in the warm coconut oil (approximately 85° F.) and mix well.
4. Add Water 2 to form a homogeneous emulsion under shearing.
5. Cool the emulsion immediately after being made.
6. Add calcium sulfate to the mixture of TVP and Citri-Fi TX10
7. Dilute enzyme (pectin methyl esterase) in water 3 and add to the mixture and mix well.
8. Add solidified emulsion to the mixture and mix well.
9. Form 85 g patties in a 3 oz. round mold and store in refrigerator overnight.
10. Keep the patties under room temperature for 1 h and cook them with a double side grill under 350° F. for 5 minutes.

Quantification of Sizzling Effect:
1. Weight the uncooked patty
2. Cook the patty and move it on a paper towel.
3. Adsorb the water and/or oil on the surface of the patty with a paper towel.
4. Weight the cooked patty.
5. Calculate the released liquid according to the following equation.

$$Released Liquid ( \% ) = \frac{( Weight of Uncooked Patty - Weight of Cooked Patty )}{Sum of water and oil in the formula} \times 100 \%$$

Results:
Less liquid released with increased of Citri-Fi TX10 usage rate due to high water holding capacity of TX10.
Compared with untreated TX10, enzyme treatment caused more released liquid with the Citri-Fi TX10 usage rate between 0-4%.

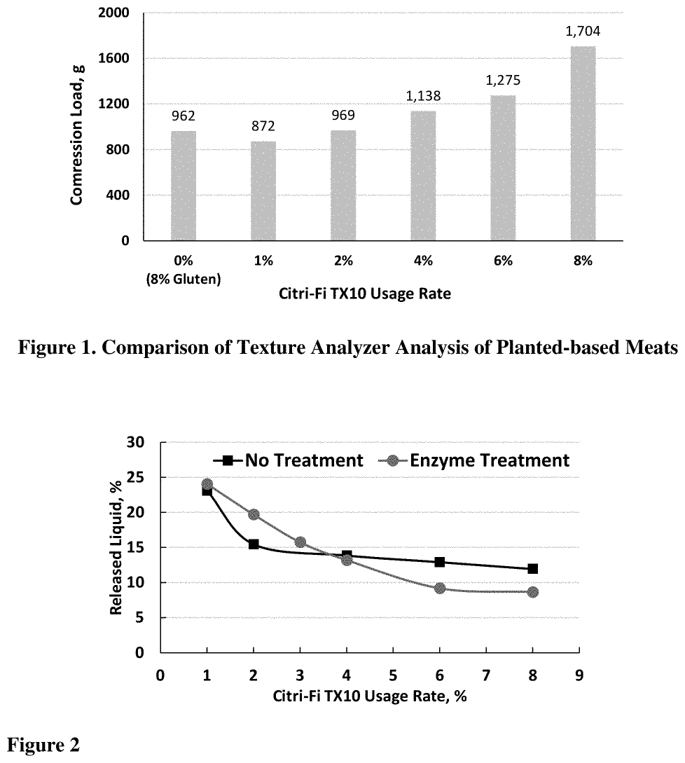

See FIG. 1 for a graphic representation of the results.

### Example 2

### Effect of Coconut and Canola Oil at Different Ratios

### Formula:

| | Coconut Oil/Canola Oil Ratio | | | | |
|---|---|---|---|---|---|
| Ingredients | 0:100 | 25:75 | 50:50 | 75:25 | 100:0 |
| Pea TVP | 22 | 22 | 22 | 22 | 22 |
| Citri-Fi | 4 | 4 | 4 | 4 | 4 |
| TX10 | | | | | |
| Water 1 | 33 | 33 | 33 | 33 | 33 |

Emulsion Phase

| | | | | | |
|---|---|---|---|---|---|
| Coconut Oil | 0 | 3.5 | 7 | 10.5 | 14 |
| Canola Oil | 14 | 10.5 | 7 | 3.5 | 0 |
| Citri-Fi | 1 | 1 | 1 | 1 | 1 |
| 100FG | | | | | |
| Water 2 | 42 | 32.7 | 26 | 21 | 17.1 |
| Total | 100 | 100 | 100 | 100 | 100 |

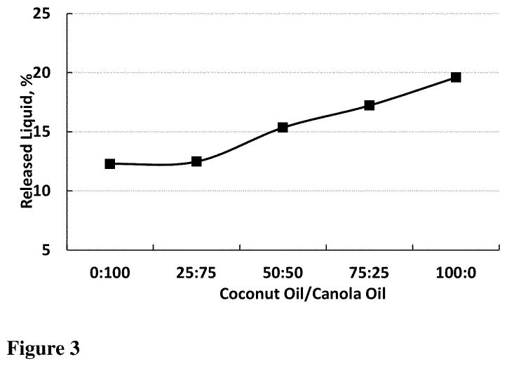

Procedures: Same as formula in above example
Results: Increasing the amount of coconut oil in the emulsion phase helped to increase the amount of released liquid and the sizzling effect as shown in FIG. 3.

The use of specific examples, materials and numbers in the specification and abstract are intended to support and enable the generic scope of the claimed generic invention and are not intended to narrow the scope of protection of those claims.

What is claimed:

1. A method of forming an expanded volume, refined cellulose coarse fiber product: a) including at least 0.005% by weight pectin and b) having average diameters of 1,000 to 10,000 microns and c) having at least 30% by weight water retentivity/weight of refined cellulose coarse fiber product comprising:
a) providing a mass of raw citrus pulp with water to at least 10% up to 200% by weight water/pulp,
b) heating the mass of raw citrus pulp with water at at least 90° C. and holding the raw citrus pulp with heating for more than 30 minutes to form an expanded fiber structure,
c) cooling the expanded fiber structure to about a cooled temperature of from 30-50° C., forming a coarse refined cellulose fiber,
d) adding enzyme to the coarse refined cellulose to form a reactive mixture,
e) holding the reactive mixture for at least about 30 minutes at 30-50° C., thereby crosslinking pectin by intraparticle pectin crosslinking of the coarse fiber to make the coarse fiber swell up and be firm,
f) drying the coarse fiber after swelling, and
g) deagglomerating the refined cellulose coarse fiber product to form the expanded volume, refined cellulose coarse fiber product.

2. The method of claim 1 further including the step of adding the expanded coarse refined cellulose fiber to moist edible materials consisting essentially of plant-only based foods.

3. A method of claim 2 of using the coarse refined cellulose fiber for texture enhancement in non-animal-protein ground meat analogs.

4. A method of forming a vegan gel comprising by mixing 100 parts by total weight by:
providing 2-6 parts by weight of highly refined coarse cellulose fiber;
adding 0.75-4 parts by weight alginate to the highly refined coarse cellulose fiber,
adding 20-50 parts by weight edible vegan oil;
solubilizing an acid in water; and
add the acid in water to the combination of the alginate and the highly refined coarse cellulose fiber to attain a gel-forming composition of 100 parts by weight at a pH of between 3-3.4 with mixing, thereby to form the edible vegan gel.

5. The method of claim 4 wherein calcium is added along with the alginate.

6. The method of claim 5 wherein a calcium source is added as 0.001-0.2 parts of the 100 parts by weight.

7. The method of claim 5 wherein the alginate and highly refined coarse cellulose fiber are added to the edible vegan oil.

8. The method of claim 7 wherein the edible vegan oil is derived from natural products selected from the group consisting of grains, fruits and vegetables.

9. The method of claim 5 wherein the edible vegan gel does not form a pourable liquid when heated to 40 C.

10. The method of claim 5 wherein the highly refined coarse cellulose fiber has a number average diameter of at least 1000 microns and less than 10,000 microns.

11. The method of claim 5 wherein the vegan gel is combined with gel soy product.

12. The method of claim 5 wherein vegan flavorant is added before gelation to form the vegan gel.

13. A method of forming an expanded volume, refined cellulose coarse fiber product: a) including at least 0.005% by weight pectin and b) having average diameters of 1,000 to 10,000 microns and c) having at least 30% by weight water retentivity/weight of refined cellulose coarse fiber product comprising:
providing a mass of raw citrus pulp with water to at least 10% up to 200% by weight water/pulp,
heating the mass of raw citrus pulp with water at 90+C and holding the raw citrus pulp with heating for more than 30 minutes to form an expanded fiber structure,
cooling the expanded fiber structure to about a cooled temperature of from 30-50° C., forming a coarse refined cellulose fiber, forming a reactive mixture,
holding the reactive mixture for at least about 30 minutes at 30-50° C., thereby crosslinking pectin by intraparticle pectin crosslinking of the coarse fiber to make the coarse fiber swell up and be firm,
drying the coarse fiber after swelling, and
deagglomerating the refined cellulose coarse fiber product to form the expanded volume, refined cellulose coarse fiber product.

14. The method of claim 1 wherein protein sourced from grains, legumes, beans and/or mushrooms are combined with the deagglomerated expanded volume, refined cellulose coarse fiber product.

15. The method of claim 2 wherein protein sourced from grains, legumes, beans and/or mushrooms are combined with the deagglomerated expanded volume, refined cellulose coarse fiber product.

16. The method of claim 3 wherein protein sourced from grains, legumes, beans and/or mushrooms are combined with the deagglomerated expanded volume, refined cellulose coarse fiber product.

17. The method of claim 13 wherein protein sourced from grains, legumes, beans and/or mushrooms are combined with the deagglomerated expanded volume, refined cellulose coarse fiber product.
